(19) United States
(12) Patent Application Publication
(10) Pub. No.: US 2023/0200622 A1
(43) Pub. Date: Jun. 29, 2023

(54) DEBRIS COLLECTOR

(71) Applicant: Mark MURGANA, Chadstone (AU)

(72) Inventor: Mark MURGANA, Chadstone (AU)

(21) Appl. No.: 18/065,178

(22) Filed: Dec. 13, 2022

(30) Foreign Application Priority Data
Dec. 24, 2021 (AU) 2021904279

(51) Int. Cl. A47L 25/00

(52) U.S. Cl. CPC A47L 25/005; B25G 1/04

(57) ABSTRACT

A head for a debris collector including a mounting member configured to be pivotably connected to a handle such that the mounting member is pivotal about at least one pivot axis that is orthogonal to the longitudinal axis of the handle; and a plurality of adhesive layers removably attached to the mounting member for collecting debris, wherein the adhesive layers are removable from the mounting member one layer at a time.

### BACKGROUND

The invention relates generally, but not exclusively, to a debris collector. The debris collector may be used for collecting various forms of debris, such as hair, crumbs and lint.

Debris, such as hair, crumbs and lint, often collects on surfaces, sometimes remaining even after general cleaning with a broom or vacuum cleaner. Cleaning individual pieces of debris can be a cumbersome job. One means of cleaning debris is to use a broom to sweep debris. However, use of a broom requires a dustpan to collect the debris. Further, regular cleaning of brooms is required to remove debris stuck on the broom's bristles.

Alternatively, a vacuum cleaner may be used to suction up debris, but vacuum cleaners may result in the inadvertent disposal of loose items resting on the surface to be cleaned. Further, vacuum cleaners are typically heavy and require a power source and may therefore not be suitable or convenient for quick, patch cleaning of surfaces.

Embodiments of the invention may ameliorate problems in the prior art or provide a useful alternative.

### SUMMARY

According to a first aspect of the present invention, there is provided a head for a debris collector comprising: a mounting member configured to be pivotably connected to a handle such that the mounting member is pivotal about at least one pivot axis that is orthogonal to the longitudinal axis of the handle; and a plurality of adhesive layers removably attached to the mounting member for collecting debris, wherein the adhesive layers are removable from the mounting member one layer at a time.

Preferably, the mounting member comprises a resilient, compressible portion to which the plurality of adhesive layers attaches.

Preferably, the mounting member has a face to which the plurality of adhesive sheets attach, each adhesive sheet being adapted to collect debris from a substantially planar surface when the mounting member is pressed against said surface.

Preferably, the face of the mounting member to which the plurality of adhesive layers attaches is flat.

Preferably, the face to which the plurality of adhesive layers attaches is an undulating surface.

Preferably, the plurality of adhesive layers is arranged in a stack.

Preferably, each of the adhesive layers comprises a tab extending from an edge thereof.

Preferably, each adhesive layer of the plurality of adhesive layers is identical to one another.

Preferably, a connection between the mounting member and the handle comprises two pivot axes.

Preferably, the connection between the mounting member and the handle comprises three pivot axes.

Preferably, the mounting member is connectible to the handle by means of a clevis.

Preferably, each adhesive layer of the plurality of adhesive layers comprises a sheet of paper with adhesive applied to one side thereof.

Preferably, the mounting member is formed through an additive manufacturing process.

According to a second aspect of the present invention, there is provided a debris collector comprising: a head according to a first aspect of the present invention; and a handle pivotably connected to the head.

According to a third aspect of the present invention, there is provided a debris collector comprising: a handle; and a head pivotably connected to the handle and having a surface to which a plurality of adhesive sheets forming a stack of adhesive sheets is attachable.

Preferably, the head is releasably connected to the handle.

Preferably, the head is connectible to the handle through a sliding or twisting action.

Preferably, the handle is telescopically extendable.

Preferably, the handle has a length of at least one metre.

### BRIEF DESCRIPTION OF THE DRAWINGS

Embodiments of the present invention will now be described, by way of non-limiting example only, with reference to the accompanying drawings briefly described as follows.

FIG. 1 is a side elevation view of a debris collector.

FIG. 2 is a side perspective view of a head of the debris collector shown in FIG. 1 and a portion of the handle.

FIG. 3 is a plan view of a stack of adhesive layers.

FIG. 4 is an upper front perspective view of the debris collector shown in FIG. 1 with handle vertical.

FIG. 5 is an exploded assembly view of components of the debris collector shown in FIG. 1.

FIG. 6 is an exploded assembly view of a connector of the debris collector shown in FIG. 1.

FIG. 7 is a front perspective view of an outer shaft of the debris collector shown in FIG. 1.

FIG. 8 is a front perspective view of an inner shaft of the debris collector shown in FIG. 1.

FIG. 9 is a perspective view of a locking mechanism of the debris collector shown in FIG. 1.

FIG. 10 is a perspective view of an end cap of the debris collector shown in FIG. 1.

FIG. 11 is a perspective view of an end cap adaptor of the debris collector shown in FIG. 1.

### DETAILED DESCRIPTION

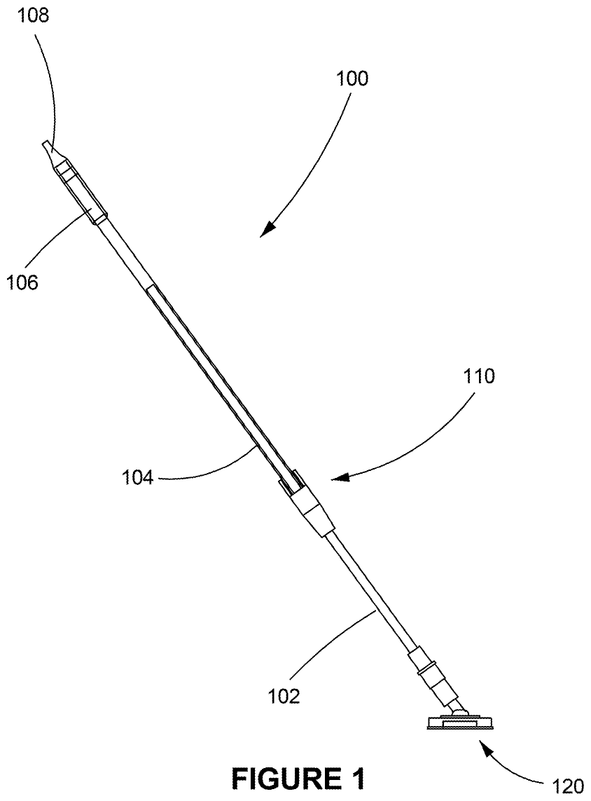

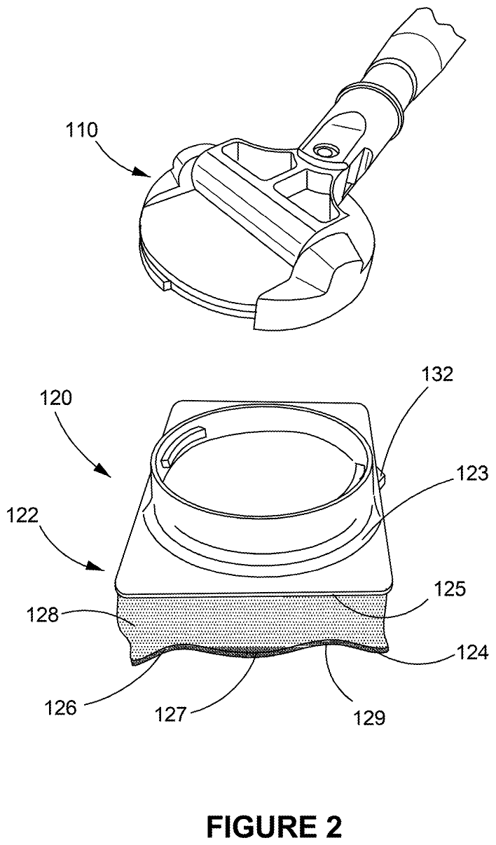

Illustrated in FIG. 1 is a mop-style debris collector (100) which can be used to collect hair, crumbs and lint amongst other things. The debris collector (100) comprises a handle (110) and a head (120), the head (120) forming the operative portion of the debris collector (100). Referring also to FIG. 2, the head (120) of the debris collector (100) comprises a mounting member (122) and a plurality of adhesive layers (124) for collecting debris. The debris collector (100) is used by pressing an adhesive side of the adhesive layers (124) against a surface from which debris is to be collected.

Although a vacuum cleaner may be used to collect dust, hair and lint from surfaces, vacuum cleaners tend to be large and heavy. In comparison, the debris collector (100) illustrated is light, compact, easy to use and does not require an external power source. Therefore, the present collector (100) may be more convenient to use.

As shown in FIGS. 2 to 4, the plurality of adhesive layers (124) is removably attached to a face (125) of the mounting member (122). Each adhesive layer is removable from the mounting member (122) one layer at a time. The adhesive layers (124) are adapted to collect debris from a surface (not shown) when the plurality of adhesive layers (124) is pressed against that surface. The surface may be any surface requiring cleaning, such as a floor or tabletop. Each of the adhesive layers (124) comprises a sheet of paper or other suitable material with adhesive applied to one side. The adhesive layers (124) removably attached to the face (125) of the mounting member (122) are arranged in a stack. The adhesive on each adhesive layer (124), except for the outermost layer, attaches the layer (124) to its adjacent layer (124) in the stack, and, when exposed, provides an adhesive surface for collecting debris.

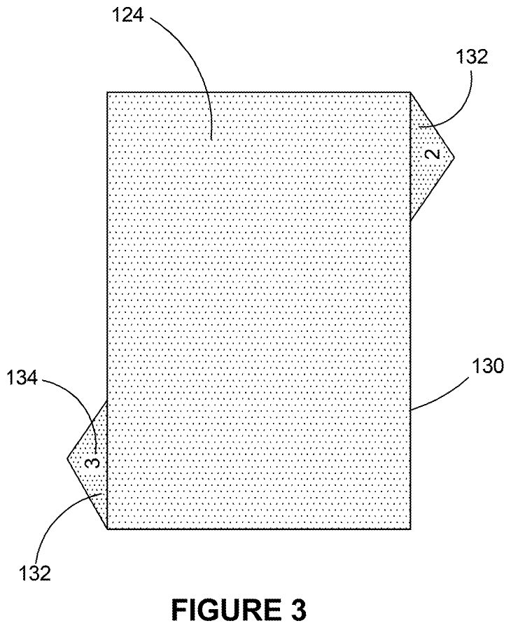

Each of the layers (124) comprises a tab (132) extending from an edge (130) of the layer (124) to facilitate removal of the layer (124) from the mounting member (122). Each layer (124) is preferably identical in shape and size to the other layers (124). The adhesive layers (124) are arranged in a stack with tabs (132) on alternating sides. Indicia (134) may also be provided on the tabs (132) to indicate the order in which the adhesive layers (132) are to be removed, and/or to provide an indication of the number of layers remaining. In the example shown in FIG. 3, the tab (132) with the number “2” is to be removed before the tab (132) with the number “3”. If the tabs (132) as manufactured have adhesive on their surfaces, sheets of paper may be placed thereon to prevent the tabs (132) of adjacent layers (124) from adhering to each other.

Advantageously, because each of the adhesive layers (124) may be removed individually from the mounting member (122), a user may collect debris from a surface and then dispose of a single adhesive layer (124) to conveniently discard the collected debris. The next adhesive layer (124) may then be used to clean another surface, such as a tabletop, without transferring the debris from the previously cleaned surface, which may have been a floor.

Referring to FIG. 2, the mounting member (122) comprises a mounting plate (123) and a resilient compressible member (128). The adhesive layers (124) are attached to the resilient compressible portion (128) by means of an adhesive or double-sided tape. The resilient, compressible portion (128) may comprise, for example, a low-density foam, sponge or other similar material, and may be formed or cut into varying shapes. In the illustrated example, the resilient, compressible portion (128) is substantially a rectangular prism, but the lower face (126) thereof is undulating. The resilient compressible portion (128) may be attached to the mounting plate (123) at face (125) of the mounting plate (123) by means of an adhesive or double-sided tape. Advantageously, the resilient compressible portion (128) is able to be deformed to conform to the contours of a surface from which debris is to be collected by applying pressure to the resilient compressible portion (128) when collecting debris. This allows the debris collector (100) to collect debris from uneven surfaces, such as those with crevices (for example, tiled surfaces that have gaps between each tile).

Due to the resilient compressible portion (128) having an undulating face (126), the adhesive layers (124) will also assume an undulating form having peaks (127) and troughs (129). Therefore, if the head (120) of the debris collector (100) is only lightly pressed against a surface, only the peaks (127) of the outermost adhesive layer (124) will be in contact with the surface. As the debris collector (100) is used, the sections of the adhesive layers (124) that have been in contact with surfaces will tend to lose their ability to adhere to debris. At this time, more pressure can be applied to the debris collector (100) to make use of the trough sections (129) of the adhesive layer (124), thus the useful life of each adhesive layer (124) is extended. Once all the adhesive layers (124) in the plurality of adhesive layers (124) have been used, the head (120) can be replaced with another head (120) having a fresh stack of adhesive layers (124). In another embodiment, only the stack of adhesive layers (124) is replaced. It will be appreciated that the adhesive collection surface provides fast and effective collection of debris and eliminates the need for a separate dust pan.

In an alternative example, the resilient, compressible portion (128) is broadly shaped as a rectangular prism with a lower flat face that is not undulating. This allows for a larger surface to be used to collect debris at once.

In an alternative example, the mounting member (122) may not include a resilient, compressible portion (128), and the adhesive layers (124) may be instead attached directly to the face (125) of the mounting plate (123).

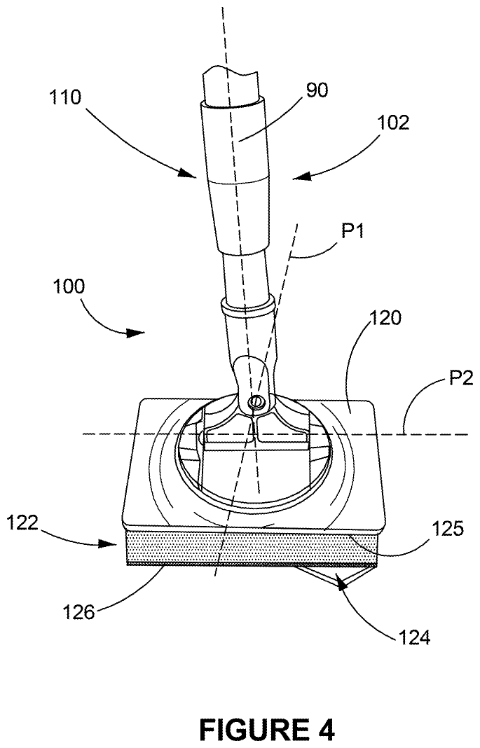

Referring now to FIG. 4, the mounting member (122) of the head (120) is configured to be pivotably connected to a handle (110) such that at least one pivot axis is orthogonal to a longitudinal axis (90) of the handle (110).

The mounting member (122) pivots about the handle (110) about at least one pivot axis that is orthogonal to the longitudinal axis (90) of the handle. This enables the user to conveniently rotate the head (120) of the debris collector (100), for example, to access hard-to-reach areas, such as crevices or under tables. The pivoting mechanism may also be used to extend the head (120) further away from the user and to draw the head (120) along an edge. In the embodiment shown in FIG. 4, the mounting member (122) is pivotable about pivot axes (P1, P2). In other embodiments, the mounting member (122) may additionally be pivotable about a rotational axis extending substantially orthogonal to the face (125) of the mounting plate (122).

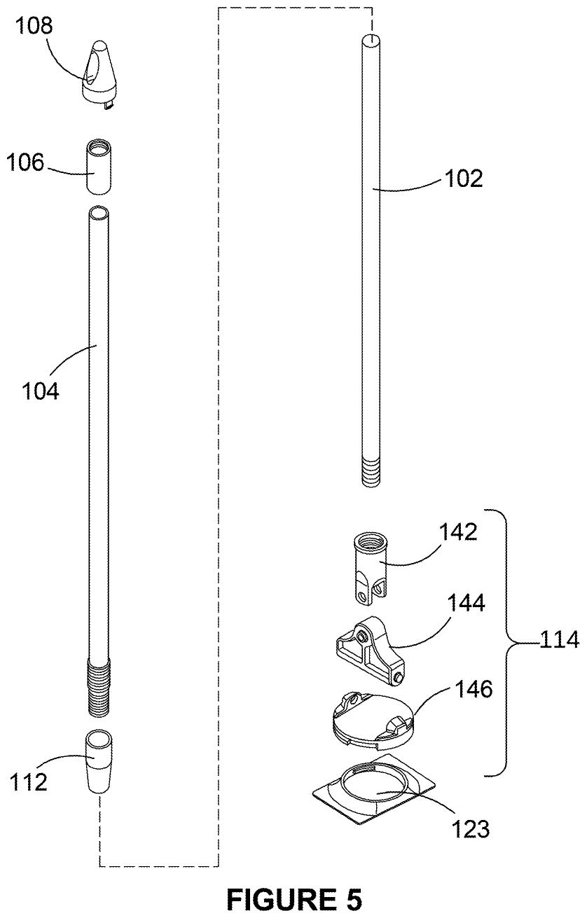

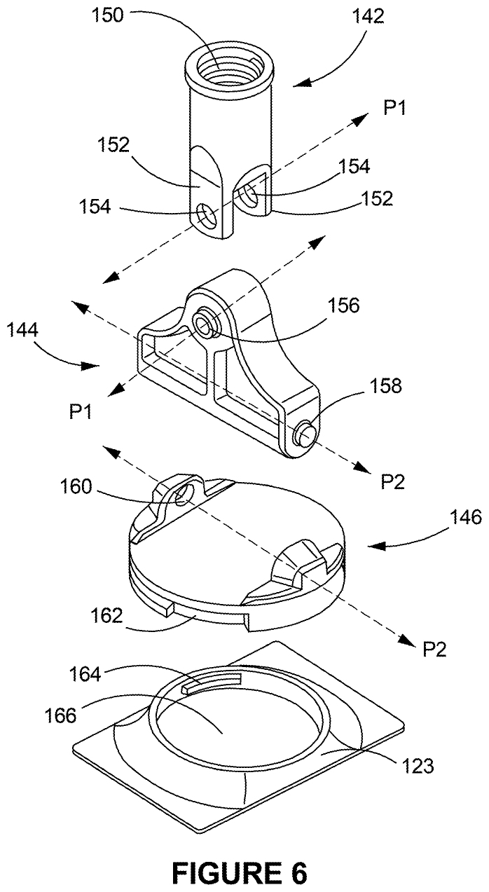

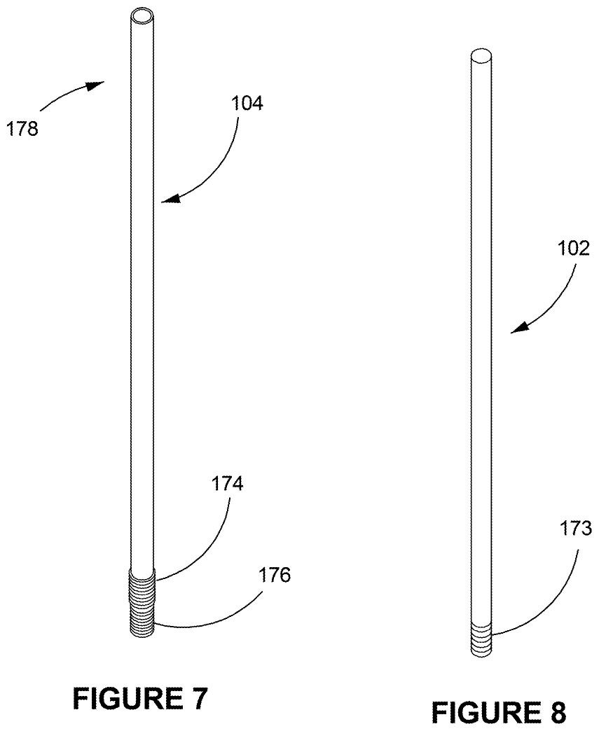

The handle (110) of the debris collector (100) is an elongate shaft structure. As shown in the exploded assembly view presented in FIG. 5, the handle (110) comprises a connector (114), inner and outer shafts (102, 104), an end cap adaptor (106), an end cap (108) and a locking mechanism (112). Alternatively, the handle may comprise a single shaft and no locking mechanism.

The connector (114) provides a connection between the mounting member (122) and the handle (110). As discussed above, the connection comprises two pivot axes, but may also comprise one or three. In particular, the connector (114) comprises multiple components so that the mounting member (122) may pivotably engage the handle (110). These components are a clevis (142), a rotational coupler (144) and circular mount (146). The clevis (142) has complementary threads to the inner shaft (102) so that it can be threadedly engaged therewith. The clevis (142) can be fitted to any handle (110) having a complementary thread (173) (see FIG. 8). Thus, the connector (114) may be used to connect the head (120) to different handles (110). The clevis (142) also has two flattened arms (152) having circular through holes (154) for receiving a respective boss (156) formed in the rotational coupler (144). The bosses (156) are a hollow extrusion from a surface of the rotational coupler (144), but may alternatively be formed as a solid extrusion.

The rotational coupler (144) is formed as a T-shaped coupler having opposed bosses (156) at one extremity for engaging the arms (152) of the clevis (142). The through holes (154) and bosses (156) form a pivot along pivot axis (P1). The rotational coupler (144) has further bosses (158) formed as trunnions at two other extremities of the rotational coupler (144) to engage recesses (160) formed in the circular mount (146). The bosses (158) and recesses (160) form a pivot along a second axis (P2).

The circular mount (146) has channels (162) formed in the periphery of its base to receive tenons/tabs (164) formed in a receptacle (166) of the mounting member (122). The channels (162) and tenons (164) cooperate to allow the head (120) through mounting member (122) to be twistingly engaged to the connector (114).

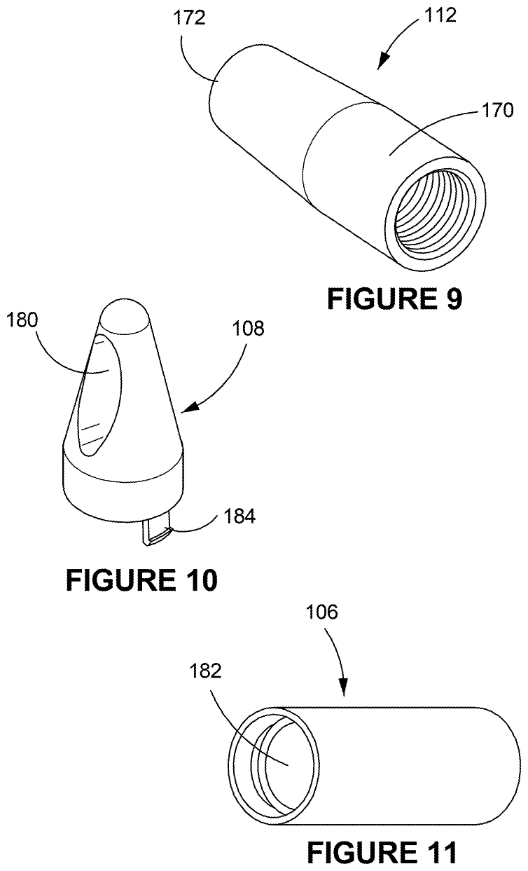

The inner shaft (102) is received within the outer shaft (104) to allow the handle (110) to be telescopically extendable by retracting or extending the inner shaft (102) from within the outer shaft (104). To secure the two shafts (102, 104) in a particular extension, a locking mechanism (112) is provided. Referring to FIG. 9, the locking mechanism (112) comprises a first portion (170) and a second portion (172). The first portion (170) is of substantially constant cross-section, whereas the second portion (172) has a tapering cross-section. The first portion (170) is threaded to engage with a threaded portion (174) of the outer shaft (104). The second portion (172) of the locking mechanism (112) is tapered to compress a deformable portion (176) of the outer shaft (104). When the locking mechanism (112) is fastened to the threaded portion (174) of the outer shaft (104), the deformable portion (176) of the outer shaft (104) clamps the outer shaft (104) to the inner shaft (102), thereby locking the two shafts (102, 104) together. In use, the locking mechanism (112) is loosened to allow the length of the handle (110) to be adjusted to a desired length. The locking mechanism (112) can then be tightened to secure the shafts (102, 104) in place. The telescopic handle (110) of the illustrated embodiment allows for the debris collector (100) to be used by users of different heights as well as for different applications. For example, a longer handle length will be preferred when cleaning floors, whereas a short handle length may be preferred when cleaning tabletops. In alternative embodiments, the shaft (104) may instead be received within the shaft (102).

The handle (110) is extendable from about 30 cm to about 2 m. More preferably, the handle is extendable from about 70 cm to about 1.25 m. Of course, other handle lengths and ranges are considered within the scope of the present specification.

Referring to FIG. 11, an end cap adaptor (106) is secured to a proximal end (178) of the handle (110). The end cap adaptor (106) receives an end cap (108). The end cap (108) is designed without sharp edges or corners so that a user's hand is not cut while using the debris collector (100). Furthermore, the end cap (108) may have a hole (180) to allow for the easy hanging of the debris collector (100).

Various components of the debris collector (100) may be manufactured using additive manufacturing, in particular plastic additive manufacturing.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above-described exemplary embodiments.

1. A head for a debris collector comprising:
a mounting member configured to be pivotably connected to a handle such that the mounting member is pivotal about at least one pivot axis that is orthogonal to the longitudinal axis of the handle; and
a plurality of adhesive layers removably attached to the mounting member for collecting debris, wherein the adhesive layers are removable from the mounting member one layer at a time.

2. The head according to claim 1, wherein the mounting member comprises a resilient, compressible portion to which the plurality of adhesive layers attaches.

3. The head according to claim 1, wherein the mounting member has a face to which the plurality of adhesive sheets attach, each adhesive sheet being adapted to collect debris from a substantially planar surface when the mounting member is pressed against said surface.

4. The head according to claim 3, wherein the face of the mounting member to which the plurality of adhesive layers attaches is flat.

5. The head according to claim 3, wherein the face to which the plurality of adhesive layers attaches is an undulating surface.

6. The head according to claim 1, wherein the plurality of adhesive layers is arranged in a stack.

7. The head according to claim 1, wherein each of the adhesive layers comprises a tab extending from an edge thereof.

8. The head according to claim 1, wherein each adhesive layer of the plurality of adhesive layers is identical to one another.

9. The head according to claim 1, wherein a connection between the mounting member and the handle comprises two pivot axes.

10. The head according to claim 9, wherein the connection between the mounting member and the handle comprises three pivot axes.

11. The head according to claim 1, wherein the mounting member is connectible to the handle by means of a clevis.

12. The head according to claim 1, wherein each adhesive layer of the plurality of adhesive layers comprises a sheet of paper with adhesive applied to one side thereof.

13. The head according to claim 1, wherein the mounting member is formed through an additive manufacturing process.

14. A debris collector comprising:
a head according to claim 1; and
a handle pivotably connected to the head.

15. A debris collector comprising:
a handle; and
a head pivotably connected to the handle and having a surface to which a plurality of adhesive sheets forming a stack of adhesive sheets is attachable.

16. The debris collector according to claim 14, wherein the head is releasably connected to the handle.

17. The debris collector according to claim 14, wherein the head is connectible to the handle through a sliding or twisting action.

18. The debris collector according to claim 14, wherein the handle is telescopically extendable.

19. The debris collector according to claim 14, wherein the handle has a length of at least one metre.
